(19) United States
(12) Patent Application Publication
(10) Pub. No.: US 2026/0023499 A1
(43) Pub. Date: Jan. 22, 2026

(54) METHOD AND NON-TRANSITORY COMPUTER-READABLE STORAGE MEDIUM AND APPARATUS FOR COLLECTING DATA BASED ON DATA TYPE

(71) Applicant: Silicon Motion, Inc., Zhubei City (TW)

(72) Inventors: Sek-Wang LAM, Taoyuan City (TW); Szu-I YEH, Hsinchu County (TW)

(73) Assignee: Silicon Motion, Inc., Zhubei City (TW)

(21) Appl. No.: 19/030,134

(22) Filed: Jan. 17, 2025

(30) Foreign Application Priority Data
Jul. 18, 2024 (CN) 202410962755.3

(51) Int. Cl. G06F 3/06

(52) U.S. Cl. CPC G06F 3/0655; G06F 3/0604; G06F 3/064; G06F 3/0679

(57) ABSTRACT

The invention introduces a method for collecting data based on data type, performed by a processing unit, to include: determining a specific data type from multiple data types; determining multiple source blocks from multiple data blocks; collecting user data of valid physical pages of the specific data type from the source blocks; and programming collected user data of the valid physical pages of the specific data type into a destination block.

### CROSS-REFERENCE TO RELATED APPLICATIONS

This application claims the benefit of priority to Patent Application No. 202410962755.3, filed in China on Jul. 18, 2024; the entirety of which is incorporated herein by reference for all purposes.

### BACKGROUND

The disclosure generally relates to storage devices and, more particularly, to a method, a non-transitory computer-readable storage medium and an apparatus for collecting data based on data type.

Flash memory devices typically include NOR flash devices and NAND flash devices. NOR flash devices are random access—a host side accessing a NOR flash device can provide the device any address on its address pins and immediately retrieve data stored in that address on the device's data pins. NAND flash devices, on the other hand, are not random access but serial access. It is not possible for NAND to access any random address in the way described above. Instead, the host side has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. How to improve the access performance of NAND flash memory has always been an important issue for NAND controllers.

### SUMMARY

In an aspect of the invention, an embodiment introduces a method for collecting data based on data type, performed by a processing unit, to include the following steps: determining a specific data type from multiple data types; determining multiple source blocks from multiple data blocks; collecting user data of valid physical pages of the specific data type from the source blocks; and programming collected user data of the valid physical pages of the specific data type into a destination block.

In another aspect of the invention, an embodiment introduces a non-transitory computer-readable storage medium having stored therein program code that, when loaded and executed by a processing unit, causes the processing unit to perform the method for collecting data based on data type as described above.

In still another aspect of the invention, an embodiment introduces an apparatus for collecting data based on data type, to include: a flash interface (I/F), coupled to a flash module; and a processing unit, coupled to the flash I/F. The processing unit is arranged operably to: determine a specific data type from multiple data types; determine multiple source blocks from multiple data blocks; drive the flash I/F to collect user data of valid physical pages of the specific data type from the source blocks of the flash module; and drive the flash I/F to program collected user data of the valid physical pages of the specific data type into a destination block of the flash module.

Both the foregoing general description and the following detailed description are examples and explanatory only, and are not restrictive of the invention as claimed.

### BRIEF DESCRIPTION OF THE DRAWINGS

FIG. 1 is the system architecture of an electronic apparatus according to an embodiment of the invention.

FIG. 2 is a schematic diagram illustrating a flash module according to an embodiment of the invention.

FIG. 3 is a schematic diagram showing the hardware architecture of a portion of a NAND flash unit according to an embodiment of the invention.

FIG. 4 is a schematic diagram showing the relationships between the high-level mapping table and the host-address to flash-address mapping (H2F) sub-tables according to an embodiment of the invention.

FIG. 5 is a schematic diagram showing the relationships between the H2F sub-table and the physical page according to an embodiment of the invention.

FIG. 6 is a sequence diagram for querying whether to support the function for managing storage based on data type according to an embodiment of the invention.

FIG. 7 is a flowchart illustrating a method for collecting data based on data type according to an embodiment of the invention.

FIG. 8 is a schematic diagram for migrating user data of a specific data type according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that changes may be made in the function and arrangement of elements without departing from the spirit and scope of the application as set forth in the claims.

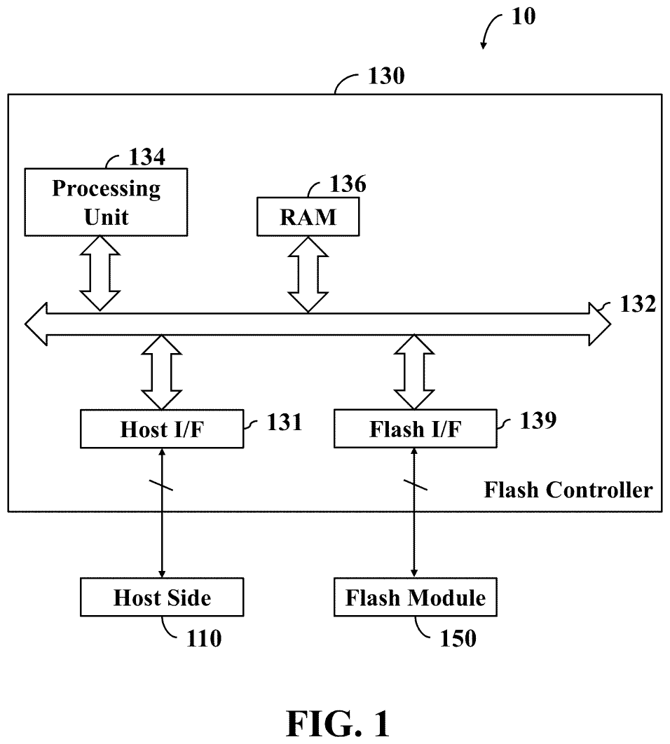

Refer to FIG. 1. The electronic apparatus 10 includes the host side 110, the flash controller 130 and the flash module 150, and the flash controller 130 and the flash module 150 may be collectively referred to as a device side. The electronic apparatus 10 may be included in an external storage device, a Personal Computer (PC), a laptop PC, a tablet PC, a mobile phone, a digital camera, a digital recorder, a smart television, a smart freezer, an automotive electronics system or other consumer electronic products. The host side 110 and the host interface (I/F) 131 of the flash controller 130 may communicate with each other by Universal Serial Bus (USB), Advanced Technology Attachment (ATA), Serial Advanced Technology Attachment (SATA), Peripheral Component Interconnect Express (PCI-E), Universal Flash Storage (UFS), Embedded Multi-Media Card (eMMC) protocol, or others. The flash I/F 139 of the flash controller 130 and the flash module 150 may communicate with each other by a Double Data Rate (DDR) protocol, such as Open NAND Flash Interface (ONFI), DDR Toggle, or others. The flash controller 130 includes the processing unit 134 and the processing unit 134 may be implemented in numerous ways, such as with general-purpose hardware (e.g., a microcontroller unit, a single processor, multiple processors or graphics processing units capable of parallel computations, or others) that is programmed using firmware and/or software instructions to perform the functions recited herein. The processing unit 134 may receive host commands from the host side 110 through the host interface (I/F) 131, such as write commands, read commands, discard commands, erase commands, etc., schedule and execute the host commands. The flash controller 130 includes the Random Access Memory (RAM) 136, which may be implemented in a Dynamic Random Access Memory (DRAM), a Static Random Access Memory (SRAM), or the combination thereof, for allocating space as a data buffer storing user data (also referred to as host data) that has been obtained from the host side 110 and is to be programmed into the flash module 150, and that has been read from the flash module 150 and is to be output to the host side 110. The RAM 136 stores necessary data in execution, such as variables, data tables, data abstracts, host-address to flash-address mapping (H2F) tables, flash-address to host-address mapping (F2H) tables, or others. The flash I/F 139 includes a NAND flash controller (NFC) to provide functions that are required to access to the flash module 150, such as a command sequencer, a Low Density Parity Check (LDPC) encoder/decoder, etc.

The flash controller 130 may be equipped with the bus architecture 132 to couple components to each other to transmit data, addresses, control signals, etc. The components include but not limited to the host I/F 131, the processing unit 134, the RAM 136 and the flash I/F 139. A direct memory access (DMA) circuitry of a component moves data between specific components through the bus architecture 132 according to instructions or control signals. For example, a DMA circuitry of the host I/F 131 or the flash I/F 139 may migrate data in a specific data buffer thereof to a specific address of the RAM 136, migrate data in a specific address of the RAM 136 to a specific data buffer thereof, and so on.

The flash module 150 provides huge storage space typically in hundred Gigabytes (GBs), or even several Terabytes (TBs), for storing a wide range of user data, such as high-resolution images, video files, etc. The flash module 150 includes control circuitries and memory arrays containing memory cells, such as being configured as Single Level Cells (SLCs), Multi-Level Cells (MLCs), Triple Level Cells (TLCs), Quad-Level Cells (QLCs), or any combinations thereof. The processing unit 134 programs user data into a designated address (a destination address) of the flash module 150 and reads user data from a designated address (a source address) thereof through the flash I/F 139. The flash I/F 139 may use several electronic signals including a data line, a clock signal line and control signal lines for coordinating the command, address and data transfer with the flash module 150. The data line may be used to transfer commands, addresses, read data and data to be programmed; and the control signal lines may be used to transfer control signals, such as Chip Enable (CE), Address Latch Enable (ALE), Command Latch Enable (CLE), Write Enable (WE), etc.

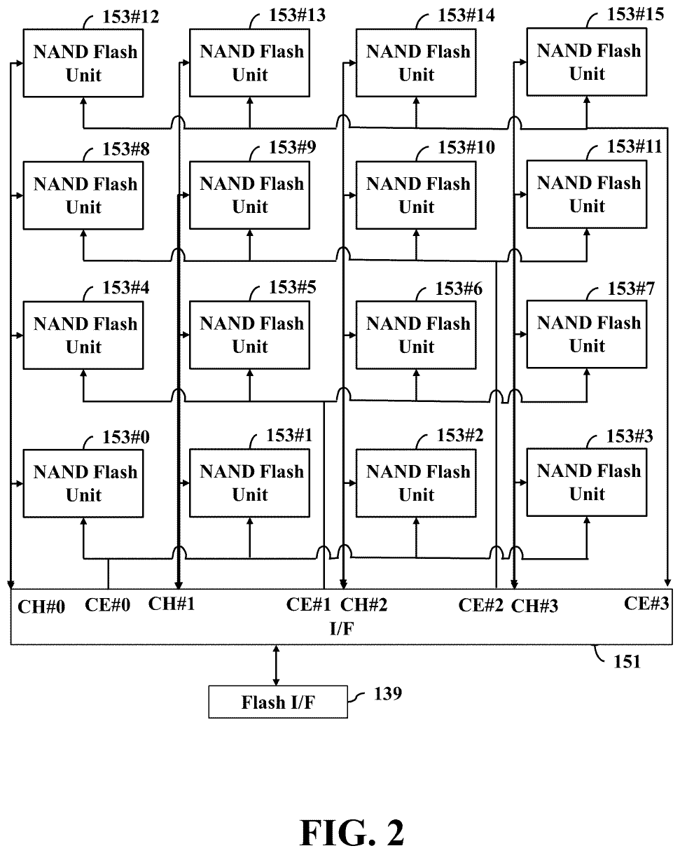

Refer to FIG. 2. The I/F 151 of the flash module 150 may include four I/O channels (hereinafter referred to as channels) CH#0 to CH#3 and each is connected to four NAND flash units, for example, the channel CH#0 is connected to the NAND flash units 150#0, 150#4, 150#8 and 150#12. Each NAND flash unit can be packaged in an independent die. The flash I/F 139 may issue one of the CE signals CE#0 to CE#3 through the I/F 151 to activate the NAND flash units 153#0 to 153#3, the NAND flash units 153#4 to 153#7, the NAND flash units 153#8 to 153#11, or the NAND flash units 153#12 to 153#15, and read data from or program data into the activated NAND flash units in parallel.

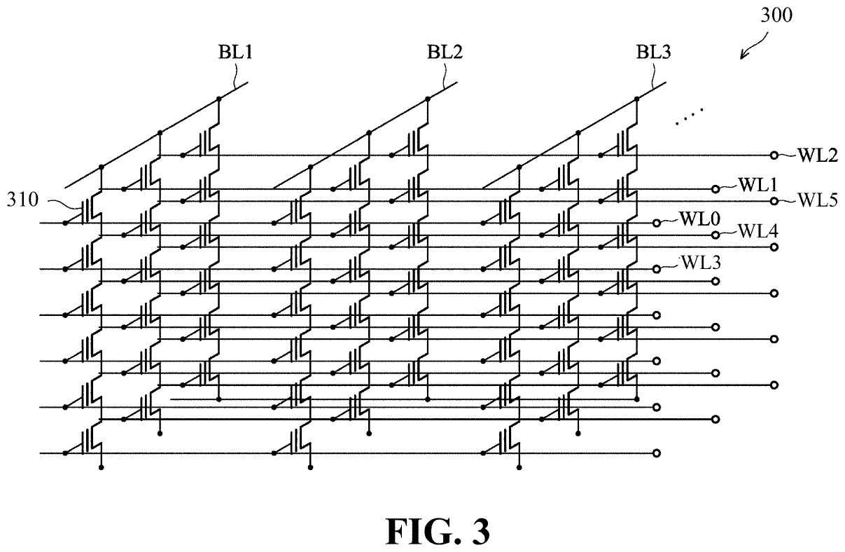

Refer to FIG. 3 showing the hardware architecture of a portion of a NAND flash unit. Each NAND flash unit may contain a plurality of memory blocks (e.g. the memory block 300) and the memory block 300 contains multiple memory cells, such as floating gate transistors (e.g. the floating gate transistor 310), or other charge trap devices. The structure of the memory block 300 includes bit lines and word lines. For brevity, only the bit lines BL1 to BL3 and the word lines WL0 to WL5 are labeled in FIG. 3. For example, the floating gate transistors on each of the word lines WL0 to WL2 and WL3 to WL5 store data on one or more pages.

Each NAND flash unit may include multiple data planes, each data plane may include multiple physical blocks. In order to improve the data programming and data reading efficiency, designated physical pages of multiple data planes across multiple NAND flash units are organized into one super page (SP). For example, in the exemplary configuration as shown in FIG. 2, each NAND flash unit includes four data planes, and each data plane includes at least one physical page of four kilobytes (KB). One SP stores user data of 256 KB (=4 channels×4 CE×4 data planes×4 KB). One super block (SB) is composed of multiple SPs. In some embodiments, any SB may be configured as a Single Level Cell (SLB) SB and each SP in the SLC SB is called SLC SP. In alternative embodiments, any SB may be configured as a Multi-Level Cell (MLC) SB and each SP in the MLC SB may be a most significant bit (MSB) SP or a least significant bit (LSB) SP. In still alternative embodiments, any SB may be configured as a Triple Level Cell (TLC) SB and each SP in the TLC SB may be an MSB SP, a center significant bit (CSB) SP or an LSB SP. In still alternative embodiments, any SB may be configured as a Quad-Level Cell (QLC) SB and each SP in the QLC SB may be a top significant bit (TSB) SP, an MSB SP, a CSB SP or an LSB SP.

In some embodiments, one logical block address (LBA) managed by the host side 110 may represent user data of 512 bytes (B), and each physical page may be divided into eight sections in 512 B. An LBA number is referred to as a logical address managed by the host side 110. An SB, a physical page and a section may be identified by a super-block number, a physical page number and a section number, respectively, and the combination of the numbers is referred to as a physical address of the flash module 150. In alternative embodiments, one host page number managed by the host side 110 may represent user data of 4 KB and each physical page is not necessary to divide into sections. A host page number is referred to as a logical address managed by the host side 110. An SB and a physical page may be identified by a super-block number and a physical page number, respectively, and the combination of the numbers is referred to as a physical address of the flash module 150.

Each SB is labeled as a data block or a current block according to its function. The processing unit 134 may select an empty SB as the current block for preparing to program user data received from the host side 110. The processing unit 134 maintains the F2H table for each current block. Each F2H table contains multiple records. Each record stores information indicating which logical address of user data that is associated with (or mapped by) a specific physical page in the current block. The records in the F2H table are stored in the order of the page numbers of physical pages in the current block. The logical address is expressed by a logical block address (LBA), a host page number or other expression and is managed by the host side 110. The processing unit 134 may drive the flash I/F 139 to program the corresponding F2H table in the RAM 136 into the data region of the designated physical page of one current block after all physical pages of this current block are fully stored in user data, or the remaining physical pages of this current block are filled with dummy values. For example, one current block may be divided into multiple banks, and the records of the F2H table corresponding to one bank of the current block are programmed into the last physical page of this bank. The current block is changed to the data block after all records of the corresponding F2H table have been programmed into the flash module 150, and the user data stored in the data block cannot be modified. Subsequently, the processing unit 134 selects an empty SB as a new current block.

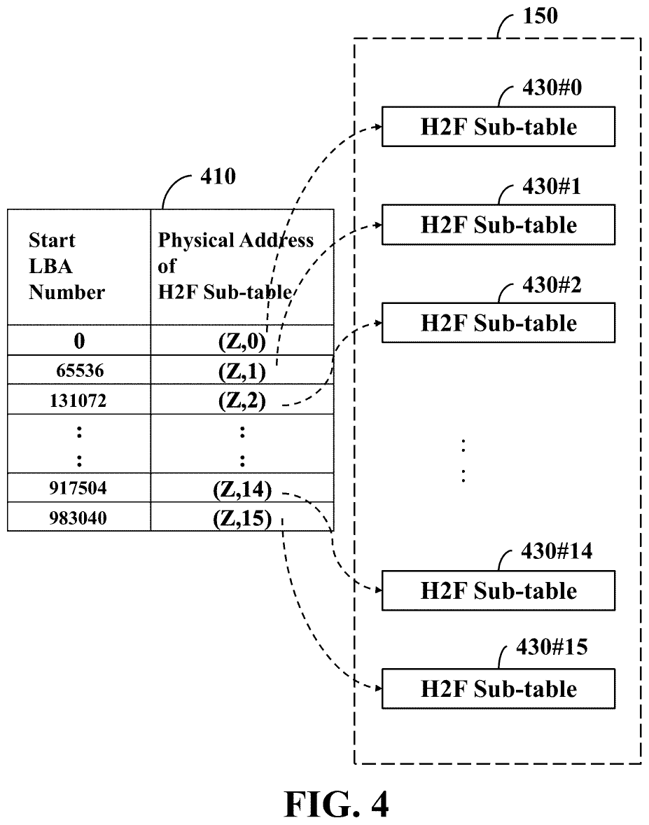

In addition to programming the F2H table into the designated physical page of the current block, the processing unit 134 updates the H2F table according to the content of F2H table, so that the processing unit 134 when executing host read commands searches the H2F table for the physical addresses user data of particular logical addresses are physically stored in later. The H2F table contains multiple records arranged in the order of the logical addresses, and each record stores information indicating which physical address user data of the corresponding logical address is physically stored in. However, because the RAM 136 cannot provide enough space to store the whole H2F table for the processing unit 134, the whole H2F table is divided into multiple H2F sub-tables and the H2F sub-tables are stored in the flash module 150, so that only necessary H2F sub-table or sub-tables are read from the flash module 150 and stored in the RAM 136 for fast look-up when data read operations are performed in the future. Referring to FIG. 4. The whole H2F table is divided into H2F sub-tables 430#0˜430#15. The processing unit 134 further maintains the high-level mapping table 410, which contains multiple records arranged in the order of the logical addresses. Each record stores information indicating which physical address the corresponding H2F sub-table for a designated logical address range is physically stored in. For example, the H2F sub-table 430#0 associated with the LBA#0 to LBA#65535 is stored in the 0^{th} physical page of a designated SB (the letter “Z” represents the number of the designated SB), the H2F sub-table 430#1 associated with the LBA#65536 to the LBA#131071 is stored in the 1^{st} physical page of the designated SB, and the remaining can be deduced by analogy. Although FIG. 4 shows 16 H2F sub-tables only, those artisans may modify the design to put more or less H2F sub-tables depending on the capacity of the flash module 150, and the invention should not be limited thereto.

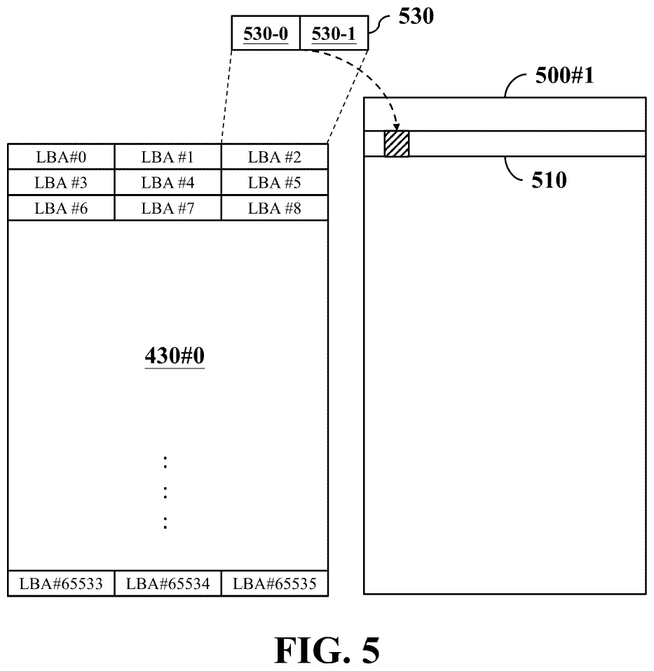

Space required by each H2F sub-table may be 16 KB, 32 KB, 64 KB, 128 KB, or others. Refer to FIG. 5. For example, the H2F sub-table stores physical-address information mapped by logical addresses in the order of the logical addresses in one logical address range. Each logical address may be represented by an LBA number and each LBA number relates to a fixed physical storage-space, such as 512 B. Those skilled in the art may use a host page number to represent a logical address and the invention should not be limited thereto. For example, the H2F sub-table 430#0 stores the physical-address information of LBA#0 to LBA#65535 sequentially. The Physical-address information 530 may be represented in four bytes: the two most-significant bytes 530-0 record a SB number and the two least-significant bytes 530-1 record a physical page number and a section number. For example, the physical-address information 530 corresponding to LBA#2 points to the section (as shown in the rectangle filled with slashes) of the physical page 510 of the SB 500#1. The bytes 530-0 records the number of the SB 500#1, and the bytes 530-1 records the number of the physical page 510 and the number of the designated section.

The host side 110 usually utilizes the file system to manage files with different data attributes. For example, it stores system program files, application files, drivers, etc. that are updated infrequently in a logical drive or logical directory, and stores system data files, application data files, etc. that are updated frequently in another logical drive or logical directory. However, typically, the flash controller 130 does not know the data attributes of user data transmitted from the host side 110 and will be programmed into the flash module 150, so that it is unable to optimize the storage location of the user data. For example, shortly after the garbage collection (GC) process performed in the flash controller 130 moves the valid user data of certain LBAs in the data blocks to the current block, the host side 110 issues host write commands to instruct the flash controller 130 to write new versions of user data of these LBAs, therefore, the moved user data of these LBAs of the current block becomes invalid.

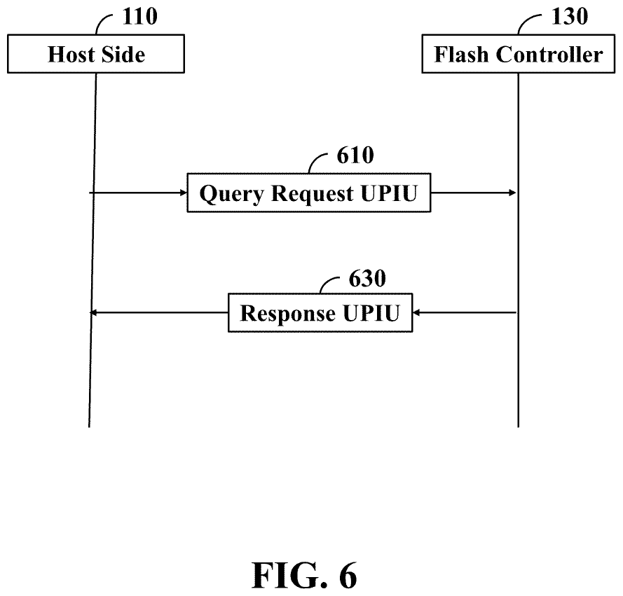

An embodiment of the invention proposes the proprietary communications protocol that makes the host side 110 to know if the flash controller 130 supports the functions for managing storage based on data type. Refer to FIG. 6 showing the sequence diagram. The host side 110 transmits the Query Request UFS Protocol Information Unit (UPIU) 610 to the flash controller 130 and the Query Request UPIU 610 includes the read descriptor Opcode, for example, DESCRIPTOR IDN=00 h, INDEX=00 h and SELECTOR=00 h, for obtaining the device descriptor from the device side. The flash controller 130 carries information of whether the flash controller 130 supports the function for managing storage based on data type in the extended UFS feature support field “dExtendedUFSFeatureSupport” of the device descriptor. The offset of the extended UFS feature support field in the device descriptor is “4Fh”. For example, the flash controller 130 uses bit[21] of the extended UFS feature support field in the device descriptor to carry information of whether the flash controller 130 supports the function for managing storage based on data type. The bit[21] of the extended UFS feature support field in the device descriptor, which is set to “1”, indicates that the flash controller 130 supports the function for managing storage based on data type. The bit[21] of the extended UFS feature support field in the device descriptor, which is set to “0”, indicates that the flash controller 130 does not support the function for managing storage based on data type. The flash controller 130 transmits the response UPIU 630 with the device descriptor to the host side 110 to notify the host side 110 of the information of whether the flash controller 130 supports the function for managing storage based on data type.

If the flash controller 130 supports the function for managing storage based on data type, the host side 110 carries not only the logical address range and the length of user data to be written, etc., but also the data type associated with the user data to be written in each host write command. For example, the host side 110 transmits the command UPIU to the flash controller 130 to instruct the flash controller 130 to program the user data of the designated logical address range into the flash module 150. The host side 110 stores information of the data type in the group number field of the command UPIU. The group number field is located in bit[4:0] of the 22^{th} byte of the command UPIU. It is noted that the host side 110 is responsible for managing the given values of the data types, and the flash controller 130 may not know the actual meaning of different data types.

In some embodiments, the data type indicates cold data or hot data. The value of the data type is set to “0 h”, which indicates cold data that is updated infrequently. The value of the data type is set to “1 h”, which indicates warm data that is updated moderately. The value of the data type is set to “2 h”, which indicates hot data that is updated frequently.

In alternative embodiments, the data type indicates system data or application data. The value of the data type is set to “0 h”, which indicates system data. The value of the data type is set to “1 h”, which indicates application data.

In alternative embodiments, the data type indicates the boot partition, the replay protected memory block (RPMB) partition, general purpose partition or user data partition. The value of the data type is set to “0 h”, which indicates data in the boot partition. The value of the data type is set to “1 h”, which indicates data in the RPMB partition. The value of the data type is set to “2 h”, which indicates data in the general purpose partition. The value of the data type is set to “3 h”, which indicates data in the user data partition.

The processing unit 134 executes program code of firmware translation layer (FTL) to complete host write commands received from the host side 110. For each host write command, the FTL stores the logical address(es) and the data type carried in this host write command in a corresponding record of the F2H table. Assume that each record in the F2H table is four bytes: The FTL stores the data type in the most-significant n bits of the four bytes of each record, and the logical address(es) in the remaining bits of the four bytes of each record, where n can be set to any integer from 1 to 5. Thus, each record in the F2H table stores information regarding which logical address of user data that the corresponding physical address in the current block is associated with (or mapped to), and the data type of the user data stored in this physical address.

Since different versions of user data of the same logical address may be stored in different physical pages in the same current block, some physical pages containing invalid data may appear in the current block. The FTL calculates a valid page count (VPC) of each data type in the current block.

In some embodiments, in addition to the corresponding F2H table, the FTL further drives the flash I/F 139 to program initial VPCs of all data types into the metadata region of the designated physical page (e.g. the last physical page) in the current block. In alternative embodiments, the FTL maintains a VPC table in the RAM 136 for storing the VPCs of all data types in all data blocks. Each time a data block is generated, the FTL updates the content of VPC table to insert information regarding the VPC of all data types in the newly generated data block. The FTL drives the flash I/F 139 to program the up-to-date VPC table into the designated physical address in the flash module 150 after updating the VPC table for a predetermined number of data blocks.

Each record in each H2F sub-table stores information regarding which physical address that user data of the corresponding logical address is physically stored at (or associated with or mapped to), and the data type of the user data of this logical address. Assume that each record in the H2F sub-table occupy four bytes, the most-significant two bytes record a SB number, and the least-significant two bytes record a physical page number and a section number: During the H2F table update process, the FTL obtains the data type and the logical address of user data, which are stored in each record of the F2H table, and accordingly updates the record in the corresponding H2F sub-table, which corresponds to this logical address. Specifically, the FTL stores the data type in the most-significant n bits of the most-significant two bytes of the corresponding record (n can be set to any integer from 1 to 5), stores the SB number in the remaining bits of the most-significant two bytes of the corresponding record, and stores the physical page number and the section number in the least-significant two bytes of the corresponding record in the corresponding H2F sub-table. Thus, each record in the H2F sub-table stores information regarding which physical address that user data of the corresponding logical address is physically stored at (or associated with, or mapped to), and the data type of the user data stored in this physical address.

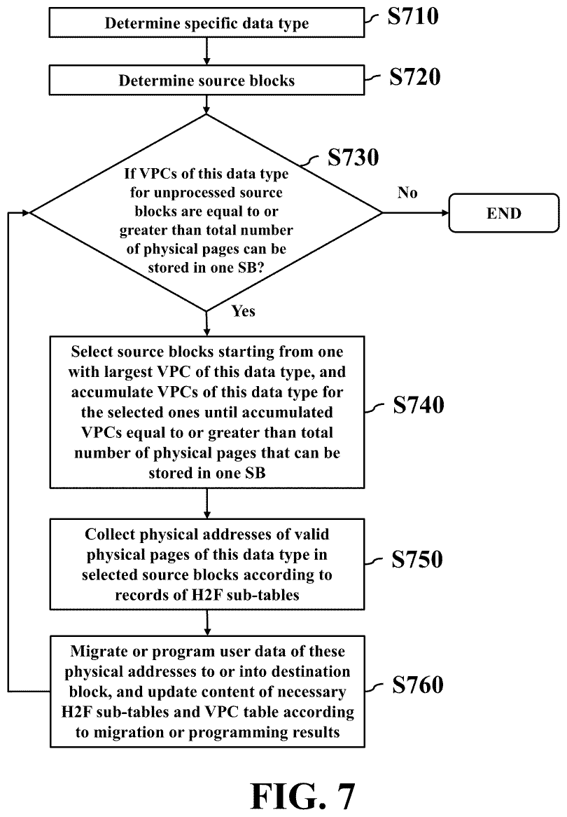

In order to decrease the migration frequencies for user data stored in the flash module 150, an embodiment of the invention proposes a method for collecting data based on data type to store user data of the same type in one data block. Refer to the flowchart as shown in FIG. 7. The processing unit 134 when loading and executing the program codes of FTL collects user data stored in valid physical pages of a specific data type from multiple source blocks in the flash module 150 and programs the collected user data stored in valid physical pages of the specific data type into a destination block in the flash module 150. The method can be activated by the flash controller 130 after a proprietary command issued by the host side 110 is received through the host I/F 131, or at a proper time point. Detailed descriptions are provided as follows:

Step S710: A specific data type, for example, the data type indicating cold data, system data or boot partition, is determined from multiple data types.

Step S720: The data blocks are sorted in descending order according to the VPCs of the specific data type for the data blocks, and a preset number (for example, 16) of the data blocks starting from the data block with the largest VPC of this data type are selected as source blocks. In some embodiments, the FTL drives the flash I/F 139 to read the VPCs of the specific data type for all data blocks from the metadata regions of the designated physical pages (for example, the last physical pages) in the data blocks of the flash module 150. In alternative embodiments, the FTL drives the flash I/F 139 to read the VPC table from the designated physical address of the flash module 150, and obtains the VPCs of the specific data type for all data blocks from the VPC table. Subsequently, the FTL sorts all data blocks in descending order according to the VPCs of the specific data type for the data blocks.

Step S730: It is determined whether the VPCs of the specific data type for the unprocessed source blocks are equal to or greater than a total number of physical pages that can be stored in one SB. If so, it means that valid user data of the specific data type in the unprocessed source blocks can be collected to fill one destination block, and the process proceeds to step S740. Otherwise, it means that valid user data of the specific data type in the unprocessed source blocks cannot be collected to fill one destination block, and the process ends.

Step S740: The source blocks are selected starting from the source block with the largest VPC of the specific data type, and the VPCs of this data type for the selected source blocks are accumulated until the accumulated VPCs of this data type for the selected source blocks are equal to or greater than the total number of physical pages that can be stored in one SB. For example, although the determined number of source blocks is 16 in step S720, the FTL in step S740 discovers that only 6 of them can satisfy the condition that valid user data of this data type in these 6 source blocks can be collected to fill one destination block.

Step S750: The physical addresses of the valid physical pages of the specific data type in the selected source blocks are collected according to the records of the H2F sub-tables.

Step S760: The flash I/F 139 is driven to read user data from these physical addresses and program the read user data into the designation block, and the content of necessary H2F sub-tables and the VPC table is updated according to the migration (or programming) results.

The FTL may repeatedly execute the loop composed of steps S730 to S760 to migrate (or program) the valid user data of the specific data type in the source blocks determined in step S720 to (or into) two or more destination blocks.

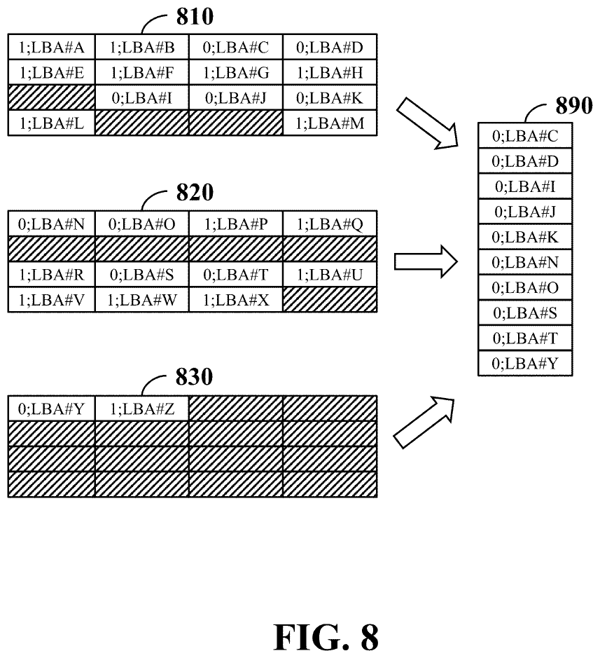

Refer to use cases as shown in FIG. 8. Assume that the data type of user data to be migrated is determined in step S710 to be “0” and the source blocks 810, 820 and 830 are selected in step S740: The blocks filled with slashes in the blocks 810, 820 and 830 indicate invalid physical pages. In each block indicating a valid physical page in the source blocks 810, 820 and 830, the number to the left of the semicolon represents the data type, and the symbol to the right of the semicolon represents the logical address of the user data of the corresponding physical page. The FTL when executing step S760 drives the flash I/F 139 to migrate the valid user data of the logical addresses “LBA#C”, “LBA#D”, “LBA#I”, “LBA#J” and “LBA#K” stored in the source block 810 to the destination block 890, the valid user data of the logical addresses “LBA#N”, “LBA#O”, “LBA#S” and “LBA#T” stored in the source block 820 to the destination block 890, and the valid user data of the logical address “LBA#Y” to the destination block 890.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims.

One having ordinary skill in the art will readily understand that the invention as discussed above may be practiced with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent.” etc.)

The term “device” or “module” is not limited to one or a specific number of physical objects (such as one smartphone, one controller, one processing system and so on). As used herein, a device may be any electronic device with one or more parts that may implement at least some portions of the invention in this disclosure. While the description and examples use the term “device” or “module” to describe various aspects of this disclosure, the term “device” or “module” is not limited to a specific configuration, type, or number of objects. Additionally, the term “system” or “module” is not limited to multiple components or specific aspects. For example, a system may be implemented on one or more printed circuit boards or other substrates and may have movable or static components. While the description and examples use the term “system” to describe various aspects of the invention in this disclosure, the term “system” is not limited to a specific configuration, type, or number of objects.

Specific details are provided in the description above to provide a thorough understanding of the aspects and examples provided herein. However, it will be understood by one of ordinary skills in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Some or all of the aforementioned embodiments of the method of the invention may be implemented in a computer program such as a driver for a dedicated hardware, a Firmware Translation Layer (FTL) of a storage device, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Although the embodiment has been described as having specific elements in FIGS. 1-3, it should be noted that additional elements may be included to achieve better performance without departing from the spirit of the invention. Each element of FIGS. 1-3 is composed of various circuitries and arranged to operably perform the aforementioned operations. While the process flows described in FIG. 7 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for collecting data based on data type, performed by a processing unit, comprising:
determining a specific data type from a plurality of data types;
determining a plurality of source blocks from a plurality of data blocks;
collecting user data of valid physical pages of the specific data type from the source blocks; and
programming collected user data of the valid physical pages of the specific data type into a destination block.

2. The method of claim 1, comprising:
sorting the data blocks in descending order according to valid page counts (VPCs) of the specific data type for the data blocks; and
selecting a preset number of the data blocks starting from a data block with a largest VPC of the specific data type as the source blocks.

3. The method of claim 2, comprising:
reading a VPC of the specific data type from a metadata region of a designated physical page of each data block in a flash module.

4. The method of claim 2, comprising:
reading a VPC of the specific data type from a metadata region of a last physical page of each data block in a flash module.

5. The method of claim 2, comprising:
reading a VPC table from a designated physical address in a flash module; and
obtaining the VPCs of the specific data type for all data blocks from the VPC table.

6. The method of claim 1, comprising:
collecting a plurality of physical addresses of the valid physical pages of the specific data type in the source blocks according to a plurality of records of a plurality of host-address to flash-address mapping (H2F) sub-tables; and
programming user data of the physical addresses into the destination block.

7. The method of claim 6, wherein most-significant n bits of each record of each H2F sub-table stores information of data type, and remaining bits of each record of each H2F sub-table stores a physical address, where n is set to any integer from 1 to 5.

8. A non-transitory computer-readable storage medium having stored therein program code that, when loaded and executed by a processing unit, causes the processing unit to:
determine a specific data type from a plurality of data types;
determine a plurality of source blocks from a plurality of data blocks;
collect user data of valid physical pages of the specific data type from the source blocks; and
program collected user data of the valid physical pages of the specific data type into a destination block.

9. The non-transitory computer-readable storage medium of claim 8, wherein the program code that, when loaded and executed by the processing unit, causes the processing unit to:
sort the data blocks in descending order according to valid page counts (VPCs) of the specific data type for the data blocks; and
select a preset number of the data blocks starting from a data block with a largest VPC of the specific data type as the source blocks.

10. The non-transitory computer-readable storage medium of claim 9, wherein the program code that, when loaded and executed by the processing unit, causes the processing unit to:
read a VPC of the specific data type from a metadata region of a designated physical page of each data block in a flash module.

11. The non-transitory computer-readable storage medium of claim 9, wherein the program code that, when loaded and executed by the processing unit, causes the processing unit to:
read a VPC of the specific data type from a metadata region of a last physical page of each data block in a flash module.

12. The non-transitory computer-readable storage medium of claim 9, wherein the program code that, when loaded and executed by the processing unit, causes the processing unit to:
read a VPC table from a designated physical address in a flash module; and
obtain the VPCs of the specific data type for all data blocks from the VPC table.

13. The non-transitory computer-readable storage medium of claim 8, wherein the program code that, when loaded and executed by the processing unit, causes the processing unit to:
collect a plurality of physical addresses of the valid physical pages of the specific data type in the source blocks according to a plurality of records of a plurality of host-address to flash-address mapping (H2F) sub-tables; and
program user data of the physical addresses into the destination block,
wherein most-significant n bits of each record of each H2F sub-table stores information of data type, and remaining bits of each record of each H2F sub-table stores a physical address, where n is set to any integer from 1 to 5.

14. An apparatus for collecting data based on data type, comprising:
a flash interface (I/F), coupled to a flash module; and
a processing unit, coupled to the flash I/F, arranged operably to: determine a specific data type from a plurality of data types; determine a plurality of source blocks from a plurality of data blocks; drive the flash I/F to collect user data of valid physical pages of the specific data type from the source blocks of the flash module; and drive the flash I/F to program collected user data of the valid physical pages of the specific data type into a destination block of the flash module.

15. The apparatus of claim 14, wherein the processing unit is arranged operably to: sort the data blocks in descending order according to valid page counts (VPCs) of the specific data type for the data blocks; and select a preset number of the data blocks starting from a data block with a largest VPC of the specific data type as the source blocks.

16. The apparatus of claim 15, wherein the processing unit is arranged operably to: drive the flash I/F to read a VPC of the specific data type from a metadata region of a designated physical page of each data block in the flash module.

17. The apparatus of claim 15, wherein the processing unit is arranged operably to: drive the flash I/F to read a VPC of the specific data type from a metadata region of a last physical page of each data block in the flash module.

18. The apparatus of claim 15, wherein the processing unit is arranged operably to: drive the flash I/F to read a VPC table from a designated physical address in the flash module; and obtain the VPCs of the specific data type for all data blocks from the VPC table.

19. The apparatus of claim 14, wherein the processing unit is arranged operably to: collect a plurality of physical addresses of the valid physical pages of the specific data type in the source blocks according to a plurality of records of a plurality of host-address to flash-address mapping (H2F) sub-tables; and drive the flash I/F to program user data of the physical addresses into the destination block of the flash module.

20. The apparatus of claim 19, wherein most-significant n bits of each record of each H2F sub-table stores information of data type, and remaining bits of each record of each H2F sub-table stores a physical address, where n is set to any integer from 1 to 5.
